(19) United States
(12) Patent Application Publication
(10) Pub. No.: US 2014/0168069 A1
(43) Pub. Date: Jun. 19, 2014

(54) ELECTRONIC DEVICE AND LIGHT PAINTING METHOD FOR CHARACTER INPUT

(71) Applicants: HON HAI PRECISION INDUSTRY CO., LTD., New Taipei (TW); HONG FU JIN PRECISION INDUSTRY (WuHan) CO.,LTD., Wuhan (CN)

(72) Inventors: CHUN-SHENG CHEN, New Taipei (TW); JING WANG, Wuhan (CN); DAO-WEI LI, Wuhan (CN); XI-HUAI HE, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/103,874

(22) Filed: Dec. 12, 2013

(30) Foreign Application Priority Data
Dec. 17, 2012 (CN) 2012105472809

(51) Int. Cl. G06F 3/0354

(52) U.S. Cl. CPC G06F 3/03542
USPC 345/156

(57) ABSTRACT

A light painting method for character input using an electronic device includes adjusting an image capturing device according to preset capturing parameters. The image capture device is enabled to capture a light painting image of a lighting device at each predetermined time interval. The light painting image is converted to a reflection image when the light painting image is a mirror image. The method recognizes a movement path of light in the reflection image, and generates a character corresponding to the movement path of the light.

### BACKGROUND

1. Technical Field

Embodiments of the present disclosure relate to data input technology, and particularly to an electronic device and a light painting method for character input using the electronic device.

2. Description of Related Art

Data input can be implemented using a physical keyboard, a virtual keyboard, handwriting input, or mouse input. However, these kinds of data inputs are limited to be executed on the physical keyboard or a touch panel of an electronic device. Therefore, an improved method for character input using the electronic device is desired.

### BRIEF DESCRIPTION OF THE DRAWINGS

FIG. 1 is a block diagram of one embodiment of an electronic device comprising a character input system.

FIG. 2 is a schematic diagram of one embodiment of a conversion of a mirror image.

FIG. 3 is a flowchart of one embodiment of a light painting method for character input using the character input system of FIG. 1.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

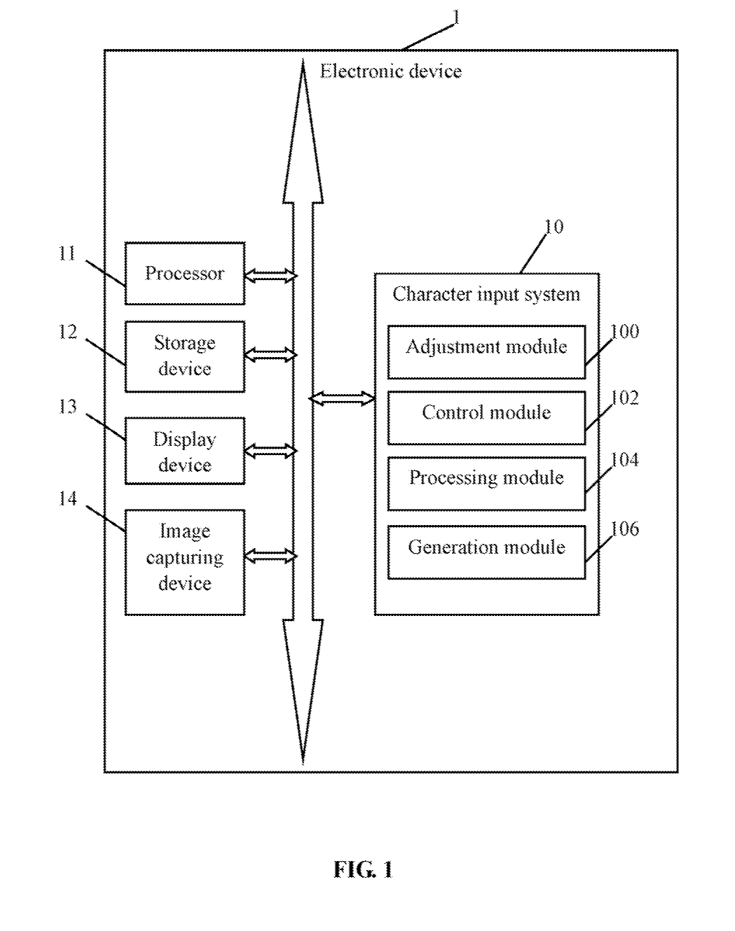

FIG. 1 is a block diagram of one embodiment of an electronic device 1 comprising the character input system 10. The electronic device 1 can be a communication device (e.g., a mobile phone), a tablet computer, a personal digital assistant, a notebook computer, or any other computing device. The electronic device 1 includes at least one processor 11, a storage device 12, a display device 13, and an image capturing device 14. In other embodiments, the electronic device 1 can include more or fewer components than illustrated, or have a different configuration of the various components.

The at least one processor 11 is used to execute the character input system 10 and other applications, such as an operating system installed in the electronic device 1. The storage device 12 stores one or more programs, such as the operating system and applications of the electronic device 1. The storage device 12 can be a storage card, such as a memory stick, a smart media card, a compact flash card, a secure digital card, or any other type of memory storage device. In some embodiments, the storage device 12 comprises a plurality of character libraries, which may comprise, but are not limited to, a Chinese word library, an English word library, a symbol library, a French word library, a number library, etc. The word libraries are used to store literal codes, which can be recognized and processed by the processor 11.

The display device 13 displays visible data, such as characters, videos, or images, for example. The image capturing device 14 is used to capture images.

In some embodiments, a user may face the image capturing device 14 and hold a lighting device to trace out characters in the air (e.g., light painting), and the image capturing device 14 captures a light painting image of the lighting device. For example, the lighting device may be a laser pen, an infrared pen, or a flashlight. The characters comprise, but are not limited to Chinese characters, letters, numbers, and/or symbols.

The character input system 10 acquires the light painting image from the image capturing device 14, acquires a reflection image of the light painting image (e.g., the light painting image is a mirror image), recognizes a movement path of light in the light painting image, and generates a character corresponding to the movement path of the light.

By utilizing the character input system 10, the determined characters may be inputted into the electronic device 1 directly, or transmitted to another electronic device (not shown in FIG. 1) and displayed on a display device of the another electronic device through a wireless connection or a data cable. Detailed descriptions are provided below.

The character input system 10 may include computerized instructions in the form of one or more programs that are executed by the at least one processor 11 and stored in the storage device 12. In one embodiment, the character input system 10 includes one or more modules, for example, an adjustment module 100, a control module 102, a processing module 104, and a generation module 106. In general, the word “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non- transitory computer-readable medium include CDs, DVDs, BLU-RAY, flash memory, and hard disk drives.

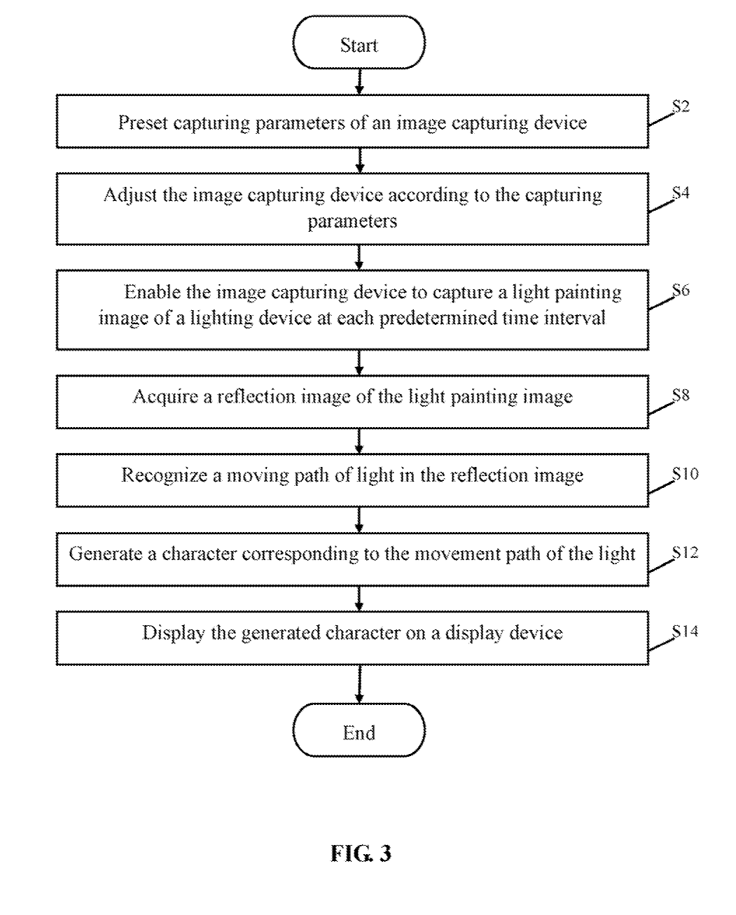

FIG. 3 is a flowchart of one embodiment of a light painting method for character input using the character input system 10 of FIG. 1. Depending on the embodiment, additional steps may be added, others removed, and the ordering of the steps may be changed.

In step S2, the adjustment module 100 presets capturing parameters of the image capturing device 14 to capture a light painting action of a user. In some embodiments, the capturing parameters may comprise, but are not limited to a shutter parameter, apertures parameters, and a sensitivity of the image capturing device 14. For example, the shutter parameter may be a shutter speed (also called “exposure time”) of the image capturing device 14, and shutter speed can be preset to be slow (e.g., >=5 seconds) for capturing the light painting action of the user better. The apertures parameters may be F16, F22, or F32, and the sensitivity may be 100 or 200, for example.

In step S4, the adjustment module 100 adjusts the image capturing device 14 according to the capturing parameters, when the character input system 10 is invoked. In other embodiments, the adjustment module 100 may record current capturing parameters of the image capturing device 14 before adjusting, and restore the current capturing parameters when the character input system 10 is disabled or exited.

In step S6, the control module 102 enables the image capturing device 14 to capture a light painting image of the lighting device at each predetermined time interval (e.g., 5 seconds). During the predetermined time interval, the user may hold the lighting device to trace out one or more characters in the air.

In step S8, the processing module 104 acquires a reflection image of the light painting image. As the user faces the image capturing device 14 to trace out the character(s) by holding the lighting device, the light painting image is a mirror image, and the processing module 104 acquires the reflection image of the light painting image.

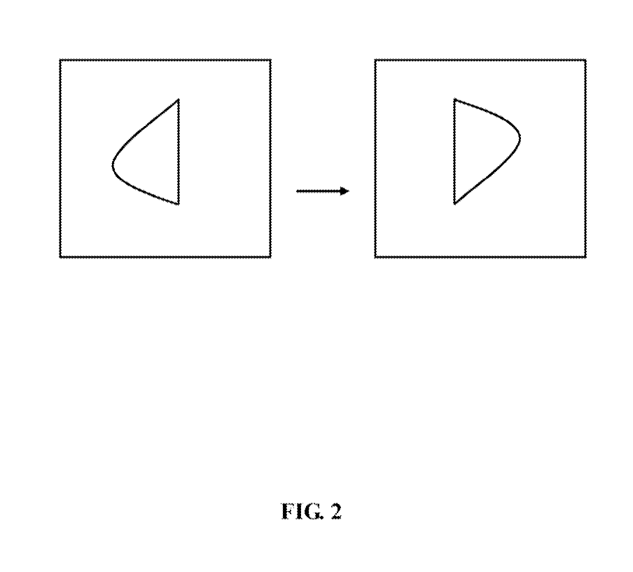

As shown in FIG. 2, the image capturing device 14 captures a light painting image comprising a reversed character “D”, after the processing module 104 processing the light painting image, a reflection image comprising a character “D” is acquired.

In other embodiments, the processing module 104 further processes the light painting image by enhancing contrast of the light painting image, darkening a background color of the light painting image, and/or filtering noises in the light painting image.

In step S10, the generation module 106 recognizes a movement path of light in the reflection image. The generation module 106 may utilize known image recognition technologies to recognize the movement path.

In step S12, the generation module 106 generates a character corresponding to the movement path of the light. The generation module 106 transforms the movement path into literal codes, determines a corresponding character by comparing the literal codes of the movement path with data in the word library, and then generates the character. Other known technologies can be used to identify the character according to the movement path.

In other embodiments, when no character is generated according to the movement path, the generation module 106 provides an error message to prompt the user of the electronic device 1 to input again.

In step S14, the generation module 106 displays the generated character and/or the movement path on the display device 13.

In other embodiments, the generation module 106 may further transmit the generated characters to a designated electronic device, and displays the generated characters on a display device of the designated electronic device.

It should be emphasized that the above-described embodiments of the present disclosure, particularly, any embodiments, are merely possible examples of implementations, set forth for a clear understanding of the principles of the disclosure.

Many variations and modifications may be made to the above-described embodiment(s) of the disclosure without departing substantially from the spirit and principles of the disclosure. All such modifications and variations are intended to be included herein within the scope of this disclosure and the present disclosure is protected by the following claims.

What is claimed is:

1. A computer-implemented light painting method for character input using an electronic device, the electronic device comprising an image capturing device, the method comprising:
presetting capturing parameters of the image capturing device;
adjusting the image capturing device according to the capturing parameters when starting inputting characters;
enabling the image capturing device to capture a light painting image of a lighting device at each predetermined time interval;
acquiring a reflection image of the light painting image under the condition that the light painting image is a mirror image; and
recognizing a movement path of light in the reflection image, and generating a character corresponding to the movement path of the light.

2. The method according to claim 1, further comprising:
processing the light painting image by enhancing contrast of the light painting image, darkening a background color of the light painting image, and/or filtering noises in the light painting image.

3. The method according to claim 1, wherein the capturing parameters comprise a shutter parameter, apertures parameters, and a sensitivity of the image capturing device.

4. The method according to claim 1, further comprising:
providing an error message to prompt a user of the electronic device to input again or providing one or more reference characters which are similar to the movement path, when no character is generated according to the movement path.

5. The method according to claim 1, wherein the lighting device is a laser pen, an infrared pen, an electric torch, or a flashlight.

6. An electronic device comprising:
an image capturing device;
at least one processor; and
a storage devices storing a plurality of instructions, which when executed by the processor, causes the at least one processor to:
preset capturing parameters of the image capturing device;
adjust the image capturing device according to the capturing parameters when starting inputting characters;
enable the image capturing device to capture a light painting image of a lighting device at each predetermined time interval;
acquire a reflection image of the light painting image under the condition that the light painting image is a mirror image; and
recognize a movement path of light in the reflection image, and generate a character corresponding to the movement path of the light.

7. The electronic device according to claim 6, wherein the at least one processor further processes the light painting image by enhancing contrast of the light painting image, darkening a background color of the light painting image, and/or filtering noises in the light painting image.

8. The electronic device according to claim 6, wherein the capturing parameters comprise a shutter parameter, apertures parameters, and a sensitivity of the image capturing device.

9. The electronic device according to claim 6, wherein the at least one processor further provides an error message to prompt a user of the electronic device to input again or provides one or more reference characters which are similar to the movement path, when no character is generated according to the movement path.

10. The electronic device according to claim 6, the lighting device is a laser pen, an infrared pen, an electric torch, or a flashlight.

11. A non-transitory storage medium having stored thereon instructions that, when executed by a processor of an electronic device, causes the electronic device to perform a lighting painting method for character input using the electronic device, the electronic device comprising an image capturing device, the method comprising:
presetting capturing parameters of the image capturing device;
adjusting the image capturing device according to the capturing parameters when starting inputting characters;
enabling the image capturing device to capture a light painting image of a lighting device at each predetermined time interval;
acquiring a reflection image of the light painting image under the condition that the light painting image is a mirror image; and
recognizing a movement path of light in the reflection image, and generating a character corresponding to the movement path of the light.

12. The non-transitory storage medium according to claim 11, wherein the method further comprises:
processing the light painting image by enhancing contrast of the light painting image, darkening a background color of the light painting image, and/or filtering noises in the light painting image.

13. The non-transitory storage medium according to claim 11, wherein the capturing parameters comprise a shutter parameter, apertures parameters, and a sensitivity of the image capturing device.

14. The non-transitory storage medium according to claim 11, wherein the method further comprises:
providing an error message to prompt a user of the electronic device to input again or providing one or more reference characters which are similar to the movement path, when no character is generated according to the movement path.

15. The non-transitory storage medium according to claim 11, wherein the lighting device is a laser pen, an infrared pen, an electric torch, or a flashlight.
